(19) United States
(12) Patent Application Publication
(10) Pub. No.: US 2025/0375839 A1
(43) Pub. Date: Dec. 11, 2025

(54) METHOD, APPARATUS, AND PROGRAM FOR ANOMALY DETECTION BASED ON ULTRASONIC WELDING DATA

(71) Applicant: AIBIZ Co.,Ltd., Seoul (KR)

(72) Inventor: Seungjae HA, Seoul (KR)

(73) Assignee: AIBIZ Co.,Ltd., Seoul (KR)

(21) Appl. No.: 18/763,812

(22) Filed: Jul. 3, 2024

(30) Foreign Application Priority Data
Jun. 5, 2024 (KR) 10-2024-0073464

(51) Int. Cl. B23K 31/00; B23K 20/10; B23K 31/12

(52) U.S. Cl. CPC B23K 31/006; B23K 20/10; B23K 31/125

(57) ABSTRACT

Disclosed is a method for anomaly detection based on ultrasonic welding data according to various embodiments of the present invention. The method includes acquiring ultrasonic welding data, generating relational data based on a correlation between data items included in the ultrasonic welding data, generating input data based on the ultrasonic welding data and the relational data, and processing the input data as an input of a graph neural network (GNN) model to calculate an outlier score and detecting an anomaly in ultrasonic welding equipment based on the calculated outlier score, and the GNN model includes an embedding model that captures a unique embedding vector corresponding to each piece of data included in the input data, and an attention module that calculates an attention weight based on the embedding vector corresponding to each piece of data and predicts a next value of a graph based on the calculated attention weight.

### CROSS-REFERENCE TO RELATED APPLICATION

This application claims priority to and the benefit of Korean Patent Application No. 10-2024-0073464, filed on Jun. 5, 2024, the disclosure of which is incorporated herein by reference in its entirety.

### BACKGROUND

### 1. Field of the Invention

The present invention relates to a method, apparatus, and program for anomaly detection based on ultrasonic welding data, and more particularly, to technology for effectively analyzing and processing data generated during a welding process using various types of sensors.

### 2. Discussion of Related Art

Laser welding and ultrasonic welding are technologies that use high-power lasers and ultrasonic vibrations, respectively, to weld steel or plastic, and are widely used in various industrial fields due to their accuracy and efficiency.

For example, the conventional method for anomaly detection or welding quality inspection in laser welding involved operators performing manual inspection on some samples. This method relies heavily on the experience and skill of the operators during an inspection process and has the limitation that the overall welding quality has to be evaluated through inspection of only some samples.

As another example, in anomaly detection or welding quality inspection in conventional ultrasonic welding, operators also performed inspection on only some samples similarly. In ultrasonic welding, a method of heating and joining a weld area through ultrasonic vibrations is used. Even in this method, there was a problem of lowering confidence in overall quality due to inspection of only some samples.

In the conventional methods for anomaly detection or welding quality inspection, reliability in the quality of the entire welding work was decreased due to low reliability due to sample inspection, specifically because inspection was performed on only some samples. In addition, in the conventional methods, when monitoring data was collected using various type of sensors for the entire sample, operators individually checking and interpreting the monitoring data took up much time and resources. In addition, in the conventional methods, it was difficult to perform consistent quality evaluation because differences depending on an operator's skill level occurred in a process of interpreting the collected monitoring data.

To solve these problems, monitoring systems using artificial intelligence (AI) are being proposed. AI-based monitoring systems can demonstrate excellent performance in processing and analyzing large amounts of data, but because they do not take into account relationships between sensors, accurate quality evaluation may not be achieved. That is, if an AI model independently analyzes data collected from the respective sensors, accurate quality evaluation may be difficult because the AI model cannot take into account interactions or relationships between the sensors. In addition, if monitoring overly relies on the AI model, performance may degrade depending on training data of the AI model or algorithm, and actual monitoring performance may degrade.

Therefore, in order to overcome the limitations and problems of the related art, a new monitoring system that may analyze data by taking into account relationships between the sensors and perform consistent and reliable quality evaluation, anomaly detection, and the like for the entire sample while reducing reliance on the AI model is needed. In this regard, Korean Registered Patent Publication No. 10-2572304 discloses a method and system for providing real-time welding inspection and defect prevention services based on artificial intelligence algorithms.

### SUMMARY OF THE INVENTION

The present invention is directed to providing a method, apparatus, and program for anomaly detection based on ultrasonic welding data.

The technical problems of the present invention are not limited to the technical problems mentioned above, and other technical problems that are not mentioned will be clearly understood by those skilled in the art from the description below.

According to an aspect of the present invention, there is provided a method for anomaly detection based on ultrasonic welding data. The method includes acquiring ultrasonic welding data, generating relational data based on a correlation between data items included in the ultrasonic welding data, generating input data based on the ultrasonic welding data and the relational data, and processing the input data as an input of a graph neural network (GNN) model to calculate an outlier score and detecting an anomaly in ultrasonic welding equipment based on the calculated outlier score, and the GNN model includes an embedding model that captures a unique embedding vector corresponding to each piece of data included in the input data, and an attention module that calculates an attention weight based on the embedding vector corresponding to each piece of data and predicts a next value of a graph based on the calculated attention weight.

In an alternative embodiment, the ultrasonic welding data may include first sensor data obtained by measuring energy applied to a welding material, second sensor data obtained by measuring a force applied to the welding material by a horn provided in the ultrasonic welding equipment, third sensor data obtained by measuring an ultrasonic operating frequency in the horn, fourth sensor data obtained by measuring an ultrasonic amplitude of the horn, fifth sensor data obtained by measuring a distance the horn has moved from an ultrasonic trigger point, and sixth sensor data obtained by measuring vibration acceleration at an anvil or the horn provided in the ultrasonic welding equipment.

In an alternative embodiment, the method may further include generating envelope data based on the sixth sensor data included in the ultrasonic welding data when the ultrasonic welding data is acquired.

In an alternative embodiment, the generating of the relational data based on the correlation between the data items included in the ultrasonic welding data may include generating at least one relational graph based on the first sensor data, the second sensor data, the third sensor data, the fourth sensor data, the fifth sensor data, the sixth sensor data, and the envelope data; and generating relational data corresponding to the at least one relational graph.

In an alternative embodiment, the method may further include separating the ultrasonic welding data into preset stages when the ultrasonic welding data is acquired. In an alternative embodiment, the generating of the relational data based on the correlation between the data items included in the ultrasonic welding data may include generating a relational graph between data for each of the plurality of sensors included in the ultrasonic welding data for each stage, and generating relational data corresponding to the relational graph, and the input data may be classified for each stage.

In an alternative embodiment, the method may further include acquiring past ultrasonic welding data, selecting normal assumption data from the past ultrasonic welding data, separating the normal assumption data into preset stages when the normal assumption data is selected, generating a relational graph between data for each of a plurality of sensors included in the normal assumption data for each stage, and generating relational data for training corresponding to the relational graph, and training the GNN model based on the past ultrasonic welding data and the relational data for training, and the selecting of the normal assumption data among the ultrasonic welding data may include extracting reference data for each of the plurality of sensors from which the past ultrasonic welding data was collected, calculating a similarity value between the data for each of the plurality of sensors included in the past ultrasonic welding data and the reference data for each of the plurality of sensors, and selecting specific welding data whose similarity value is greater than or equal to a preset value as the normal assumption data.

In an alternative embodiment, the GNN model may be a neural network model that has learned a graph of relationships between data using graph deviation, and the GNN model may output predicted data through correlation analysis between data included in the input data and calculate the outlier score through a comparison between the actually acquired ultrasonic welding data and the predicted data.

According to another aspect of the present invention, there is provided an apparatus. The apparatus includes a memory that stores one or more instructions, and a processor that executes the one or more instructions stored in the memory, and the processor performs the methods described above by executing the one or more instructions.

According to still another aspect of the present invention, there is provided a computer program that is stored in a computer-readable recording medium and, when executed by being combined with a computer which is hardware, causes the methods described above to be performed.

Other specific details of the present invention are included in the detailed description and accompanying drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating a system according to an embodiment of the present invention;

FIG. 2 is a hardware configuration diagram of a computing device according to an embodiment of the present invention;

FIGS. 3 to 6 are diagrams for describing a method for anomaly detection based on ultrasonic welding data according to an embodiment of the present invention; and

FIG. 7 is a schematic diagram illustrating one or more network functions related to an embodiment of the present invention.

### DETAILED DESCRIPTION OF EXEMPLARY EMBODIMENTS

Exemplary embodiments of the present invention will be described in detail below with reference to the accompanying drawings. In this specification, various descriptions are presented to provide an understanding of the present invention. However, it is clear that these embodiments may be practiced without these specific descriptions.

The terms “component,” “module,” “system,” and the like used herein refer to a computer-related entity, hardware, firmware, software, a combination of software and hardware, or an execution of software. For example, a component may be, but is not limited to, a procedure running on a processor, a processor, an object, an execution thread, a program, and/or a computer. For example, both an application running on a computing device and the computing device may be a component. One or more components may reside within a processor and/or an execution thread. A single component may be localized within one computer. A single component may be distributed between two or more computers. In addition, these components may be executed by being loaded from various computer-readable media having various data structures stored therein. Components may communicate via local and/or remote processes, for example, via signals having one or more data packets (e.g., data from a component interacting with other components in a local system or a distributed system, and/or data received and transmitted over a network such as the Internet from and to other systems via signals).

In addition, the term “or” is intended to mean an inclusive “or” and not an exclusive “or.” That is, unless otherwise specified or clear from context, “X uses A or B” is intended to mean one of natural inclusive substitutions. That is, when X uses A, X uses B, or X uses both A and B, “X uses A or B” may apply to any of these cases. In addition, the term “and/or” used herein should be understood to refer to and include all possible combinations of one or more of the related listed items.

In addition, the terms “comprise” and/or “comprising” should be understood to mean that a corresponding feature and/or component is present. However, the terms “comprise” and/or “comprising” should be understood as not excluding the presence or addition of one or more other features, components and/or groups thereof. In addition, unless otherwise specified or the context is clear to indicate a singular form, a singular term used herein and in the claim should generally be construed to mean “one or more.”

Those skilled in the art should additionally recognize that various exemplary logical blocks, configurations, modules, circuits, means, logics, and algorithm steps described in connection with the embodiments disclosed herein may be implemented in electronic hardware, computer software, or a combination of both. To clearly illustrate the interchangeability of hardware and software, various exemplary components, blocks, configurations, means, logics, modules, circuits, and steps have been described above generally in terms of their functionality. Whether such functionality is implemented in hardware or software depends on specific applications and design constraints imposed on the overall system. Skilled technicians may implement the described functionality in a variety of ways for the respective specific application. However, such implementation decisions should not be construed as departing from the scope of the present invention.

The description of the presented embodiments is provided so that those skilled in the art of the present invention may use or practice the present invention. Various modifications to these embodiments will be apparent to those skilled in the art of the present invention. The general principles defined herein may be applied to other embodiments without departing from the scope of the invention. Therefore, the present invention is not limited to the embodiments presented herein. The present invention is to be interpreted in the broadest scope consistent with the principles and novel features presented herein.

In this specification, a computer is any type of hardware devices including at least one processor, and depending on an embodiment, it may be understood as encompassing software configurations that run on the corresponding hardware device. For example, the computer may be understood to include, but is not limited to, a smartphone, a tablet PC, a desktop, a laptop, and user clients and applications running on each device.

Hereinafter, embodiments of the present invention will be described in detail with reference to the accompanying drawings.

Each step described in this specification is described as being performed by a computer, but the subject of each step is not limited thereto, and depending on an embodiment, at least part of each step may be performed in a different device.

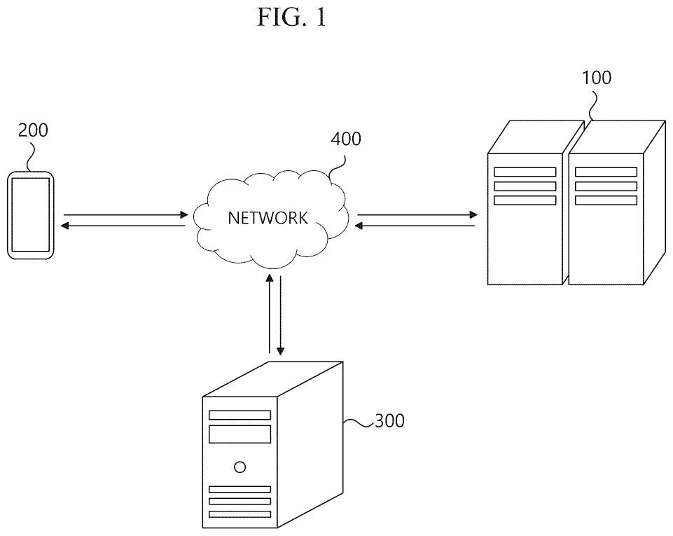

FIG. 1 is a diagram illustrating a system according to an embodiment of the present invention.

Referring to FIG. 1, the system according to the embodiment of the present invention may include a computing device 100, a user terminal 200, and an external server 300. The system illustrated in FIG. 1 is a system according to the embodiment, and its components are not limited to those of the embodiment illustrated in FIG. 1, and may be added, changed, or deleted as necessary.

In an embodiment, the computing device 100 may perform a method for anomaly detection based on ultrasonic welding data.

Specifically, the computing device 100 may acquire ultrasonic welding data. In addition, the computing device 100 may generate relational data based on a correlation between data items included in the ultrasonic welding data. In addition, the computing device 100 may generate input data based on the ultrasonic welding data and the relational data. In addition, the computing device 100 may process the input data as an input of a graph neural network (GNN) model to calculate an outlier score, and detect an anomaly in ultrasonic welding based on the calculated outlier score.

In an embodiment, the GNN model of the present invention may include an embedding model that captures a unique embedding vector corresponding to each piece of data included in the input data, and an attention module that calculates an attention weight based on the embedding vector corresponding to each piece of data and predicts a next value of a graph based on the calculated attention weight.

Therefore, when analyzing data, the computing device 100 of the present invention may perform consistent and reliable anomaly detection on welding data by taking into account a relationship between sensors.

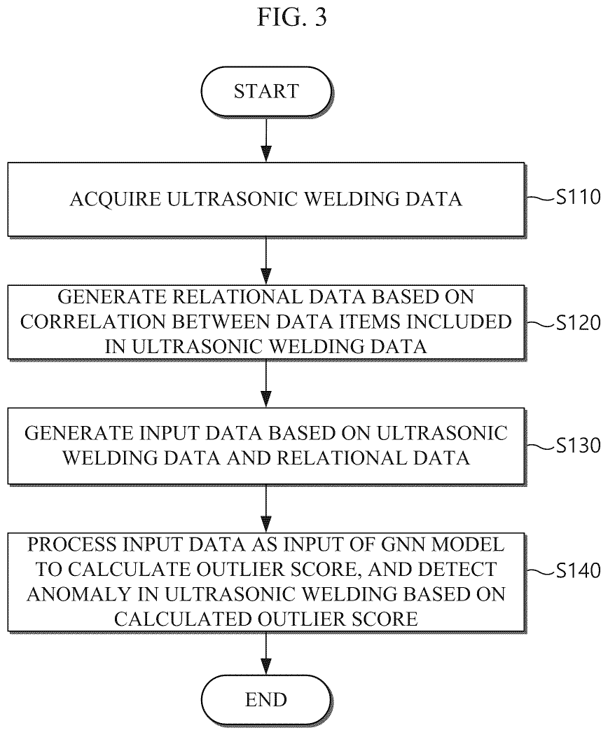

An example of how the computing device 100 performs the method for anomaly detection based on ultrasonic welding data will be described below with reference to FIGS. 3 to 7.

In an embodiment, ultrasonic welding equipment that provides ultrasonic welding data is equipment used in a process of joining two materials using ultrasonic vibration. This equipment realizes high-strength welding by promoting molecular bonding between materials through ultrasonic energy.

The ultrasonic welding equipment may include, as a major component, an ultrasonic generator that converts electrical signals into high-frequency ultrasonic vibrations. Here, the frequency may generally be between 20 kHz and 40 kHz, but is not limited thereto.

In addition, the ultrasonic welding equipment may include a transducer that converts electrical signals generated by the ultrasonic generator into mechanical vibrations. This conversion may be performed using piezoelectric elements.

In addition, the ultrasonic welding equipment may include a booster that increases the amplitude of the vibrations generated by the transducer. The booster may provide the appropriate amplitude required for welding work.

In addition, the ultrasonic welding equipment may include a horn (sonotrode) that transmits the vibrations transmitted from the booster to a workpiece. Ultrasonic energy may be transmitted by bringing the tip of the horn into direct contact with a material to be welded.

In addition, the ultrasonic welding equipment may include a jig and clamp that fix a material to be welded and apply the required pressure, and the jig and clamp fix the material so that it does not shake, thereby ensuring stable welding.

That is, in the ultrasonic welding equipment, when the ultrasonic generator generates electrical signals, the transducer may convert the electrical signals into mechanical vibrations, and the converted vibrations may be amplified through the booster and then transmitted to the horn. As the horn transmits ultrasonic vibrations to the material, the vibration energy generates heat on a contact surface of the material, and the generated heat can soften or melt the contact surface of the material to promote joining of the materials.

This ultrasonic welding equipment may complete welding within a few seconds, which may increase productivity. In addition, the ultrasonic welding equipment may provide high-strength welding due to formation of bonding at the molecular level. In addition, the ultrasonic welding equipment may minimize material deformation because it does not apply direct heat, and the ultrasonic welding equipment may provide an environmentally friendly working environment because the ultrasonic welding equipment does not use adhesives or solvents.

The ultrasonic welding equipment is mainly used to join materials such as plastics, metals, fibers, and films and may be used in various industrial fields such as secondary batteries, automobiles, electronics, medical devices, and packaging.

In various embodiments, the computing device 100 may provide web-based or application-based services. However, the computing device 100 is not limited thereto.

The computing device 100 may include any type of computer system or computer device, such as, for example, a microprocessor, a mainframe computer, a digital processor, a portable device, and a device controller. However, the computing device 100 is not limited thereto.

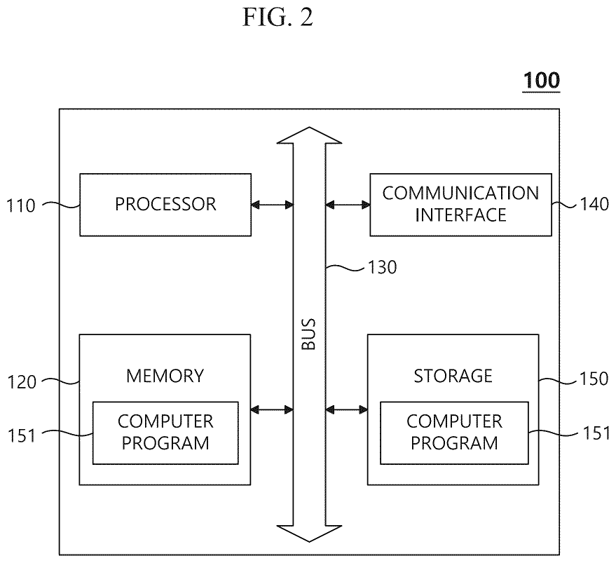

A description of a hardware configuration of the computing device 100 will be described below with reference to FIG. 2.

Meanwhile, the user terminal 200 may be connected to the computing device 100 through a network 400 and may be a user terminal that manages the method for anomaly detection based on ultrasonic welding data performed by the computing device 100.

Here, the user terminal 200 may include, for example, various types of computer devices. In more detail, for example, the user terminal 200 may be any of various terminal devices such as a smartphone, a tablet PC, a desktop, or a laptop.

The user terminal 200 may include a display in at least a portion thereof and may include an operating system for running an application-based or extension program-based service provided by the computing device 100. For example, the user terminal 200 may be a smart phone, but is not limited thereto. The user terminal 200 is a wireless communication device that guarantees portability and mobility, and may include all types of handheld wireless communication devices such as a navigation device, a personal communication system (PCS), a global system for mobile communications (GSM) device, a personal digital cellular (PDC) device, a personal handyphone system (PHS) a personal digital assistant (PDA), an international mobile telecommunication (IMT)-2000 device, a code division multiple access (CDMA)-2000 device, a W-code division multiple access (W-CDMA) device, a wireless broadband internet (WiBro) terminal, a smartpad, and a tablet PC.

The external server 300 may be connected to the computing device 100 through the network 400, may transmit and receive various types of information/data necessary for the computing device 100 to perform the method for anomaly detection based on ultrasonic welding data, and may store and manage various types of information/data generated as the computing device 100 performs the method for anomaly detection based on ultrasonic welding data.

For example, the external server 300 may be a database server that stores information used in the method for anomaly detection based on ultrasonic welding data. As another example, the external server 300 may be a server that provides information used in the method for anomaly detection based on ultrasonic welding data.

The network 400 may be a connection structure that allows information exchange between nodes such as computing devices, a plurality of terminals, and servers. For example, the network 400 includes a local area network (LAN), a wide area network (WAN), the Internet (WWW: World Wide Web), wired and wireless data communication networks, a telephone network, wired and wireless television communication networks, and the like.

Wireless data communication networks include, but are not limited to, 3G, 4G, 5G, 3^{rd} Generation Partnership Project (3GPP), 5th Generation Partnership Project (5GPP), Long Term Evolution (LTE), World Interoperability for Microwave Access (WiMAX), Wi-Fi, the Internet, a LAN, a wireless LAN, a WAN, a personal area network (PAN), radio frequency (RF), a Bluetooth network, a near-field communication (NFC) network, a satellite broadcasting network, an analog broadcasting network, a digital multimedia broadcasting (DMB) network, and the like.

FIG. 2 is a hardware configuration diagram of a computing device according to an embodiment of the present invention.

Referring to FIG. 2, the computing device 100 according to the embodiment of the present invention may include one or more processors 110, a memory 120 into which a computer program 151 executed by the processor 110 is loaded, a bus 130, a communication interface 140, and a storage 150 for storing the computer program 151. Here, only components related to the embodiment of the present invention are illustrated in FIG. 2. Accordingly, anyone skilled in the art to which the present invention pertains will know that other general-purpose components may be included in addition to the components illustrated in FIG. 2.

The processor 110 controls the overall operation of each component of the computing device 100. The processor 110 may be configured with one or more cores, and may include a processor for data analysis and deep learning of a central processing unit (CPU), a general purpose graphics processing unit (GPGPU), a tensor processing unit (TPU), etc. of the computing device. Alternatively, the processor 110 may include any type of processor well known in the art of the present invention.

In addition, the processor 110 may perform operations on at least one application or program to execute a method according to embodiments of the present invention, and may include one or more processors.

In various embodiments, the processor 110 may further include a random access memory (RAM) (not shown) and a read-only memory (ROM) (not shown) that temporarily and permanently store signals (or data) processed within the processor 110. In addition, the processor 110 may be implemented in a system-on-chip (SoC) form that includes at least one of a graphics processing unit, a RAM, and a ROM.

The processor 110 may read the computer program stored in the memory 120 and perform data processing for deep learning according to an embodiment of the present invention. According to an embodiment of the present invention, the processor 110 may perform computations for training a neural network. The processor 110 may perform computations for training the neural network, such as processing input data for training, feature extraction from input data, error calculation, and weight update in the neural network using backpropagation in deep learning (DL).

The memory 120 stores various types of data, commands and/or information. The computer program 151 may be loaded from the storage 150 into the memory 120 in order to execute methods/operations according to various embodiments of the present invention. When the computer program 151 is loaded into the memory 120, the processor 110 may perform the methods/operations by executing one or more instructions constituting the computer program 151. The memory 120 may be implemented as a volatile memory such as a RAM, but the technical scope of the present invention is not limited thereto.

The bus 130 provides a communication function between components of the computing device 100. The bus 130 may be implemented as various types of buses, such as an address bus, a data bus, and a control bus.

The communication interface 140 supports wired and wireless Internet communication of the computing device 100. In addition, the communication interface 140 may support various communication methods other than Internet communication. To this end, the communication interface 140 may include a communication module well known in the art of the present invention. In some embodiments, the communication interface 140 may be omitted.

The storage 150 may non-temporarily store the computer program 151. When performing a process according to an embodiment of the present invention through the computing device 100, the storage 150 may store various types of information required to perform a method according to the disclosed embodiment or provide a service.

The storage 150 may include a non-volatile memory such as a read only memory (ROM), an erasable programmable ROM (EPROM), an electrically erasable programmable ROM (EEPROM), and a flash memory, a hard disk, a removable disk, or any type of computer-readable recording medium well known in the art to which the present invention pertains.

The computer program 151 may include one or more instructions that cause the processor 110 to perform methods/operations according to various embodiments of the present invention when loaded into the memory 120 and executed. That is, the processor 110 may perform the methods/operations according to various embodiments of the present invention by executing the one or more instructions.

In an embodiment, the computer program 151 may include one or more instructions to perform various methods related to various tasks related to training a neural network model.

The operations of the method or algorithm described in connection with the embodiment of the present invention may be implemented directly in hardware, implemented as a software module executed by hardware, or a combination thereof. The software module may reside in a random access memory (RAM), a ROM, an EPROM, an EEPROM, a flash memory, a hard disk, a removable disk, a CD-ROM, or any form of computer-readable recording medium well known in the art to which the present invention pertains.

The components of the present invention may be implemented as a program (or an application) and stored in a medium to be executed in conjunction with a computer, which is hardware. Components of the present invention may be implemented as software programming or software elements. Similarly, embodiments may be implemented in programming or scripting languages such as C, C++, Java, assembler, and the like, including various algorithms implemented as combinations of data structures, processes, routines or other programming constructs.

Functional aspects may be implemented as algorithms running on one or more processors.

FIGS. 3 to 6 are diagrams for describing a method for anomaly detection based on ultrasonic welding data according to an embodiment of the present invention.

Referring to FIG. 3, the computing device 100 may acquire ultrasonic welding data (S110).

Specifically, the computing device 100 may acquire ultrasonic welding data from at least one sensor provided in ultrasonic welding equipment. For example, at least one sensor may be provided in ultrasonic welding equipment and may include, but is not limited to, sensors that measure energy, force, frequency or amplitude of ultrasonic waves, and a distance the horn has moved.

In an embodiment, ultrasonic welding data may include first sensor data obtained by measuring energy applied to a welding material, second sensor data obtained by measuring a force applied to the welding material by the horn provided in the ultrasonic welding equipment, third sensor data obtained by measuring an ultrasonic operating frequency in the horn, fourth sensor data obtained by measuring an ultrasonic amplitude in the horn, fifth sensor data obtained by measuring a distance the horn has moved from an ultrasonic trigger point, and sixth sensor data obtained by measuring vibration acceleration at an anvil provided in the ultrasonic welding equipment. Each of the first sensor data, the second sensor data, the third sensor data, the fourth sensor data, the fifth sensor data, and the sixth sensor data may have a correlation.

In various embodiments, when the ultrasonic welding data is acquired in operation S110, the computing device 100 may generate envelope data based on the sixth sensor data included in the ultrasonic welding data. Here, the computing device 100 may improve monitoring performance for welding quality using the envelope data together with the first to sixth sensor data.

In various embodiments, when the computing device 100 acquires ultrasonic welding data, the computing device 100 may separate and analyze the ultrasonic welding data for each stage.

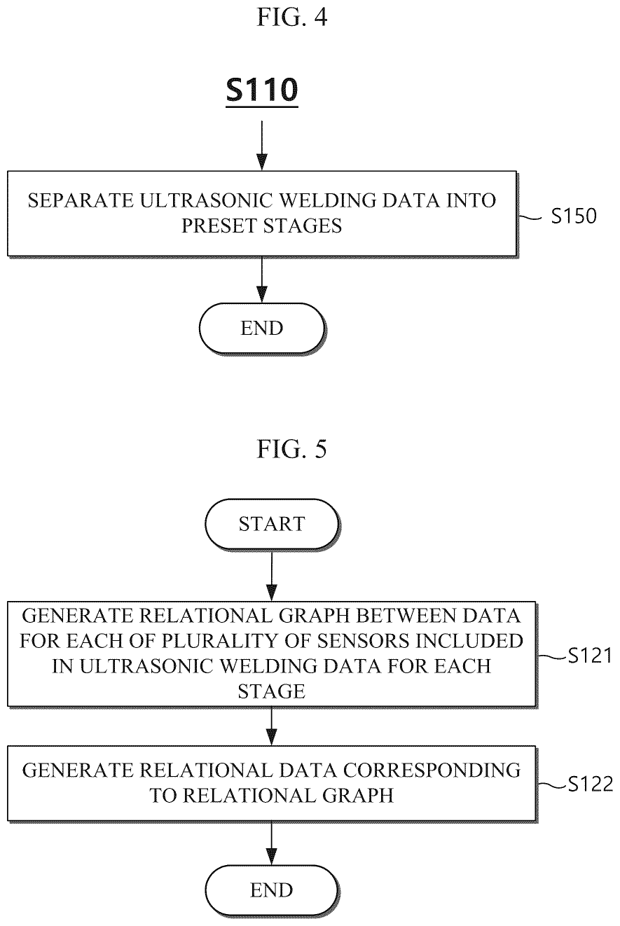

Specifically, referring to FIG. 4, the computing device 100 may separate ultrasonic welding data into preset stages (S150). Here, the preset stages correspond to an ultrasonic welding process and may include a first stage, a second stage, a third stage, and a fourth stage.

The first stage is a phase where the horn penetrates by applying force, and there may be a gap between welding materials. In addition, the second stage is a phase where an oxide film of the interface is being destroyed, and the welding materials are melted by frictional heat, allowing some of the welding materials to be joined. In addition, the third stage is a phase where elements between the welding materials are mixed due to solid diffusion, and the welding materials may be bonded. Further, the fourth stage is a phase where the material at the weld area is cooled and joined after welding is completed and may include a hold time. Here, the hold time may be ensured to be a preset time to increase the joining strength of the welded area.

Meanwhile, the computing device 100 may perform analysis and anomaly detection while separating data for each stage in the process of performing an anomaly detection method to be described below.

The computing device 100 may generate relational data based on a correlation between data items included in the ultrasonic welding data (S120).

Specifically, when generating the relational data based on the correlation between the data items included in the ultrasonic welding data, the computing device 100 may generate at least one relational graph based on the first sensor data, the second sensor data, the third sensor data, the fourth sensor data, the fifth sensor data, the sixth sensor data, and the envelope data. The computing device 100 may generate relational data corresponding to at least one relational graph.

For example, the computing device 100 may visualize an interaction between sensors by analyzing an interrelationship among sensor data, thereby clearly providing the relevancy among sensor data. The generated relational graph may be used by the computing device 100 to detect anomalies in the ultrasonic welding process and evaluate quality in real time.

More specifically, referring to FIG. 5, when generating the relational data based on the correlation between data items included in ultrasonic welding data, the computing device 100 may generate a relational graph between data for each of a plurality of sensors included in the ultrasonic welding data for each stage (S121). Then, the computing device 100 may generate relational data corresponding to the relational graph (S122).

In this case, input data input to the GNN model in a subsequent step may be classified for each stage.

For example, in the ultrasonic welding data, the first sensor data 11 may have a correlation in which the first sensor data 11 and the fourth sensor data 14 mutually influence each other and may have a correlation in which the first sensor data 11 influences the envelope data 17. In addition, in the ultrasonic welding data, the second sensor data 12 may have a correlation in which the second sensor data 12 influences the fifth sensor data 15 and the envelope data 17. In addition, in the ultrasonic welding data, the fourth sensor data 14 may have a correlation in which the fourth sensor data 14 and the first sensor data 11 mutually influence each other and may have a correlation in which the fourth sensor data 14 influences the envelope data 17. In addition, in the ultrasonic welding data, the fifth sensor data 15 may have a correlation in which the fifth sensor data 15 is influenced by the second sensor data 12 and the envelope data 17. In addition, the envelope data 17 may have a correlation in which the envelope data 17 is influenced by the first sensor data 11, the second sensor data 12, and the fourth sensor data 14, and may have a correlation in which the envelope data 17 influences the fifth sensor data 15.

As another example, in the ultrasonic welding data, the third sensor data 13 has a correlation in which the third sensor data 13 influences the sixth sensor data 16, and the sixth sensor data 16 may have a correlation in which the sixth sensor data 16 is influenced by the third sensor data.

On the other hand, during the ultrasonic welding process, sensor data and envelope data may not influence each other. That is, in a specific process, each piece of sensor data may not have a correlation.

In this way, the computing device 100 may analyze each piece of sensor data included in the ultrasonic welding data separated for each stage, grasp the correlation between the sensor data, and graph the data to generate relational data.

Meanwhile, this relational data may be input into a graph neural network (GNN) model, which will be described below, and through this, anomaly detection considering the correlation between sensors may be possible. Specifically, the computing device 100 may use the generated relational data as input data for the GNN model to detect an anomaly that may occur during the ultrasonic welding process in real time.

The computing device 100 may generate input data based on the ultrasonic welding data and the relational data (S130).

Specifically, the computing device 100 may generate the input data by integrating the ultrasonic welding data and the generated relational data, and this input data may be used as data for training and prediction of the GNN model.

In various embodiments, the computing device 100 may use the relational data as input data of the GNN model. That is, the operation of generating input data (S130) may be integrated with the operation of generating the relational data (S120) described above.

The computing device 100 may process the input data as an input of the graph neural network (GNN) model to calculate an outlier score, and detect the anomaly in ultrasonic welding based on the calculated outlier score (S140). Here, the GNN model may include an embedding model that captures a unique embedding vector corresponding to each piece of data included in the input data, and an attention module that calculates an attention weight based on the embedding vector corresponding to each piece of data and predicts a next value of a graph based on the calculated attention weight.

Specifically, the GNN model is a neural network model that learns a graph of relationships between data using graph deviations, and may be trained to output predicted data through correlation analysis between data included in the input data and calculate the outlier score through a comparison between the ultrasonic welding data actually obtained in operation S110 and the predicted data.

Meanwhile, the computing device 100 may acquire the outlier score output by the GNN model trained in this way and detect an anomaly in ultrasonic welding based on this outlier score.

In an embodiment, in the ultrasonic welding data, the first sensor data 11 may have a correlation in which the first sensor data 11 and the fourth sensor data 14 mutually influence each other and may have a correlation in which the first sensor data 11 influences the envelope data 17. In addition, in the ultrasonic welding data, the second sensor data 12 may have a correlation in which the second sensor data 12 influences the fifth sensor data 15 and the envelope data 17. In addition, in the ultrasonic welding data, the fourth sensor data 14 may have a correlation in which the fourth sensor data 14 and the first sensor data 11 mutually influence each other and may have a correlation in which the fourth sensor data 14 influences the envelope data 17. In addition, in the ultrasonic welding data, the fifth sensor data 15 may have a correlation in which the fifth sensor data 15 is influenced by the second sensor data 12 and the envelope data 17. In addition, in the ultrasonic welding data, the envelope data 17 may have a correlation in which the envelope data 17 is influenced by the first sensor data 11, the second sensor data 12, and the fourth sensor data 14, and may have a correlation in which the envelope data 17 influences the fifth sensor data 15.

For example, when a value corresponding to the first sensor data 11 increases by 30%, a value corresponding to the fourth sensor data 14, which mutually influences the first sensor data 11, may increase by 20%. In addition, a value corresponding to the envelope data 17 may increase by 25%. In contrast, when a value corresponding to the second sensor data 12 decreases by 30%, a value corresponding to the fifth sensor data 15 may decrease by 20%, and a value corresponding to the envelope data 17 may decrease by 15%.

When the GNN model trained using such data acquires input data, the GNN model may output a level at which a relationship between the values that correspond to the first sensor data 11 and the fourth sensor data 14 and a relationship between the values that correspond to the second sensor data 12 and the fifth sensor data 15 deviate from the previously learned relationship as an outlier score.

In an embodiment, in the ultrasonic welding data, the third sensor data 13 may have a correlation in which the third sensor data 13 influences the sixth sensor data 16, and the sixth sensor data 16 may have a correlation in which the sixth sensor data 16 is influenced by the third sensor data 13. For example, when a value corresponding to the third sensor data 13 increases by 50%, a value corresponding to the sixth sensor data 16 may increase by 40%. In contrast, when the value corresponding to the third sensor data 13 decreases by 30%, the value corresponding to the sixth sensor data 16 may decrease by 25%.

When the GNN model trained using such data acquires input data, the GNN model may output a level at which a relationship between the values that correspond to the third sensor data 13 and the sixth sensor data 16 deviate from the previously learned relationship as an outlier score.

As another example, in ultrasonic welding data, sensor data may have correlations that do not influence each other. For example, the value of each of the first sensor data 11, the second sensor data 12, the third sensor data 13, the fourth sensor data 14, the fifth sensor data 15, and the sixth sensor data 16 may change independently and may not be influenced by changes in other sensor data. In this case, the GNN model that has learned a pattern in which each sensor data changes independently may output the outlier score when each piece of sensor data shows a correlation without changing independently.

Through these various examples, the computing device 100 may analyze the correlation between the respective sensor data at various stages of ultrasonic welding data and input the relational data generated based on this analysis into the GNN model to detect the anomaly that may occur during the ultrasonic welding process in real time. Through this, it is possible to increase the reliability of welding quality and improve productivity.

In addition, the computing device 100 may use the generated relational data as input data of the GNN model to detect the anomaly that may occur during the ultrasonic welding process in real time, evaluate the quality of ultrasonic welding based on the outlier score, and prevent the anomaly in advance. Through this, it is possible to reduce the reliance on workers, increase the reliability of welding quality, and improve productivity.

In various embodiments, when the outlier score calculated through the GNN model exceeds a specific value (e.g., a threshold reference value), the computing device 100 may determine that an abnormal situation has occurred and generate alarm information. The computing device 100 may provide the alarm information to the user terminal 200. Here, the alarm information may be classified into at least one of a first alarm corresponding to a truth and a second alarm corresponding to an error.

Specifically, the computing device 100 may use the GNN model to analyze the correlation between a plurality of pieces of sensor data and detect the anomaly. This reduces false alarms (i.e., second alarms) triggered simply by exceeding threshold values and classifies true alarms (i.e., first alarms), which are dangerous situations, among alarms, to enable appropriate and rapid response to an actual situation, thereby enabling improvement of the productivity of ultrasonic welding.

According to an embodiment of the present invention, the computing device 100 may train the GNN model described above in advance.

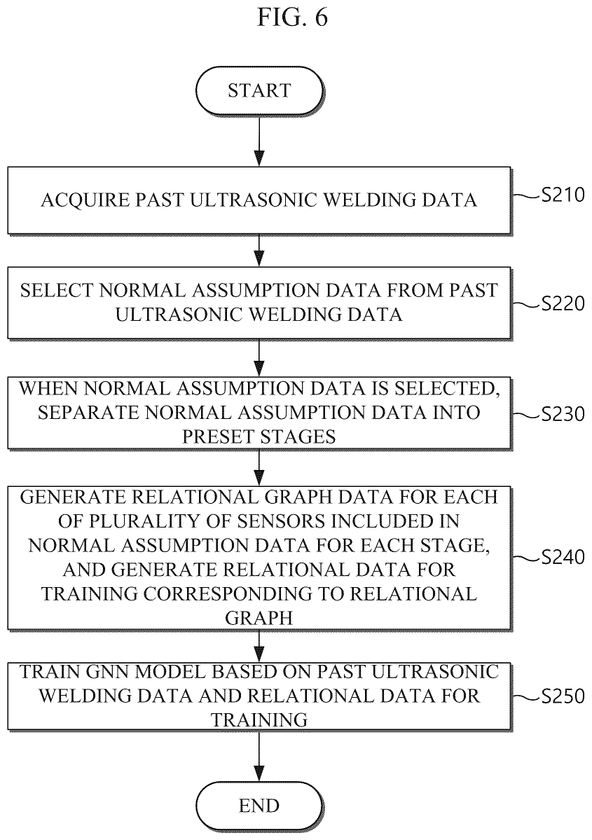

Specifically, referring to FIG. 6, the computing device 100 may acquire past ultrasonic welding data (S210). In this case, the computing device 100 may select normal assumption data from the past ultrasonic welding data (S220).

Specifically, when selecting the normal assumption data among the ultrasonic welding data, the computing device 100 may extract reference data for each of a plurality of sensors from which the past ultrasonic welding data was collected. In addition, the computing device 100 may calculate a similarity value between data for each of the plurality of sensors included in the past ultrasonic welding data and reference data for each of the plurality of sensors. In addition, the computing device 100 may select specific welding data whose similarity value is greater than or equal to a preset value as the normal assumption data.

Meanwhile, when the normal assumption data is selected, the computing device 100 may separate the normal assumption data into preset stages (S230). In addition, the computing device 100 may generate relational graph data for each of the plurality of sensors included in the normal assumption data for each stage, and generate relational data for training corresponding to the relational graph (S240). Then, the computing device 100 may train the GNN model based on the past ultrasonic welding data and the relational data for training (S250).

Specifically, when the computing device 100 trains the GNN model, the GNN model may be optimized to recognize and predict complex patterns and interactions within sensor data. In this process, the computing device 100 may use sensor data extracted for each stage to define nodes and edges of a graph neural network, thereby structuring a relationship between sensors in the form of a graph.

Thereafter, the computing device 100 trains the GNN model using the defined graph structure. This training process is performed over multiple epochs and batches, and at each training operation, weights and parameters may be adjusted to minimize a loss function. Based on these learned results, the GNN model may be used to predict various scenarios that may occur in the future ultrasonic welding process, and in particular, to detect an anomalistic symptom that deviates from a normal range.

In addition, the computing device 100 may perform an operation of evaluating and verifying the trained GNN model. In this operation, the computing device 100 may evaluate the accuracy and generalization ability of the GNN model using a verification dataset prepared separately from a training dataset. When the model shows sufficient performance, the computing device 100 may perform additional optimization prior to implementation in an actual ultrasonic welding environment.

The computing device 100 may distribute the GNN model that has passed the verification operation to an actual operating environment, monitor the ultrasonic welding process in real time, and provide feedback to a control system as needed, thereby contributing to increasing the efficiency of the welding process and improving product quality. Through training and practical application in this way, the GNN model installed on the computing device 100 may continuously collect data and repeat learning, thereby enabling more precise and efficient welding control.

In various embodiments, the computing device 100 may construct training data based on sensor data corresponding to a plurality of types of sensors and may generate the GNN model by performing training on one or more network functions using the constructed training data.

Specifically, the computing device 100 may collect training data.

In an embodiment, the computing device 100 may collect training data for training a neural network from a sensor module or an external computing device 100. For example, the computing device 100 may collect past ultrasonic welding data collected through sensors provided in various ultrasonic welding equipment that have performed welding work for many years.

This past ultrasonic welding data may be stored in the memory of the computing device 100 or may be pre-stored in an external computing device. In addition, for example, the computing device 100 may collect data related to ultrasonic welding by accessing a separate external server that stores information related to ultrasonic welding. That is, the computing device 100 may access a specific external server and crawl various types of data related to ultrasonic welding.

The computing device 100 may collect past ultrasonic welding data accumulated over many years and process the past ultrasonic welding data into data suitable for training of a neural network.

According to one embodiment, the computing device 100 may perform preprocessing and sampling on training data. The computing device 100 may resample the collected data on a per-minute basis and perform interpolation processing on missing values. Since the ultrasonic welding data is data that shows various aspects depending on the stage, appropriate data processing is required to process the ultrasonic welding data as an input of the neural network. The computing device 100 may divide each piece of ultrasonic welding data into data of a certain size (i.e., for each stage) through resampling and process the divided data of the certain size as an input of the neural network.

For example, the computing device 100 may generate, for each stage of ultrasonic welding, a graph representing the correlation between first sensor data obtained by measuring energy applied to the welding material, second sensor data obtained by measuring a force applied to the welding material by a horn provided in the ultrasonic welding equipment, third sensor data obtained by measuring an ultrasonic operating frequency in the horn, fourth sensor data obtained by measuring an ultrasonic amplitude in the horn, fifth sensor data obtained by measuring a distance the horn has moved from an ultrasonic trigger point, and sixth sensor data obtained by measuring vibration acceleration at an anvil provided in the ultrasonic welding equipment. The graphs created in this way are used as training data for training one or more network functions.

The computing device 100 may connect the nodes and the edges between sensors based on observed correlations and construct a network for graph structure learning. In addition, the computing device 100 may set hyper-parameters in the constructed network. A hyper-parameter may be a variable that may be changed by the user. The hyper-parameter may include, for example, a learning rate, a cost function, the number of training cycle repetitions, weight initialization (e.g., setting the range of weight values subject to weight initialization), and the number of hidden units (e.g., the number of hidden layers and the number of nodes in hidden layers). The detailed description of the hyper-parameter above described is only exemplary, and the present invention is not limited thereto.

Thereafter, the training data assumed to be in a normal condition may be refined in a rule-base manner, and as training is performed with outlier points of the test data labeled in a refined way, a GNN model is generated. According to one embodiment, after training of the model is complete, verification and evaluation of performance may be performed using test data.

The computing device 100 may test performance of one or more network functions using the test data to determine whether to activate one or more network functions to generate an artificial intelligence model (i.e., a GNN model). Test data may be used to verify the performance of the GNN model and may consist of at least part of the training data. For example, 70% of the training data may be used for training the GNN model (i.e., training to adjust a weight to output a result value that is similar to a label), and 30% of the training data may be used as test data to verify the performance of the GNN model. The computing device 100 may input the test data into the trained GNN model, measure an error, and determine whether to activate the GNN model depending on whether the performance of the trained GNN model is predetermined performance or higher.

The computing device 100 verifies the performance of the trained GNN model using the test data for the trained GNN model, and when the performance of the trained GNN model is a predetermined standard or higher, the computing device 100 may activate the corresponding GNN model to be used in other applications.

In addition, when the performance of the trained GNN model is the predetermined standard or lower, the computing device 100 may deactivate and discard the corresponding GNN model. For example, the computing device 100 may determine the performance of the generated GNN model based on factors such as accuracy, precision, and recall. The above-described performance evaluation criteria are only exemplary, and the present invention is not limited thereto. In various embodiments, the computing device 100 may generate a plurality of artificial intelligence models by independently training each artificial intelligence model, and may evaluate performance of the generated artificial intelligence models and use only those artificial intelligence models having certain performance or higher.

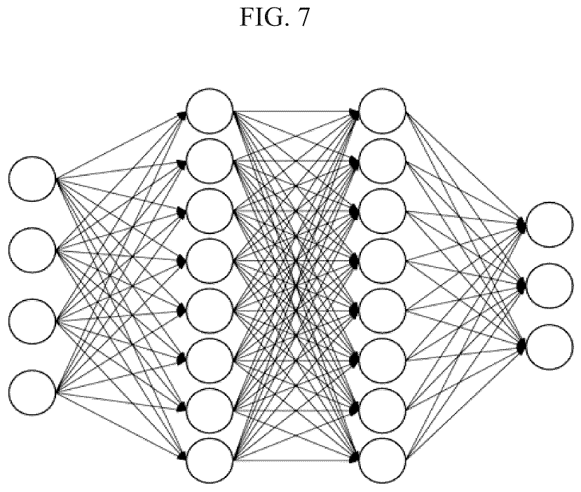

FIG. 7 is a schematic diagram illustrating one or more network functions related to an embodiment of the present invention.

Throughout this specification, an artificial intelligence model, a neural network model, a neural network, a network function may be used to have the same meaning. The neural network may generally consist of a set of interconnected computational units, which may be commonly referred to as “nodes.” These “nodes” may also be referred to as “neurons.”

A deep neural network (DNN) may be a neural network that includes multiple hidden layers in addition to an input layer and output layer. Latent structures of data can be understood using the deep neural network. That is, latent structures of a photo, text, video, voice, and music (for example, what objects are in the photo, what the content and emotion of the text are, what the content and emotion of the voice are, etc.) can be understood. Deep neural networks may include a convolutional neural network (CNN), a recurrent neural network (RNN), an auto encoder, a generative adversarial network (GAN), a restricted Boltzmann machine (RBM), a deep belief network (DBN), a Q network, a U network, a Siamese network, and the like. The deep neural networks described above are only exemplary, and the present invention is not limited thereto.

The neural network may be trained with at least one of supervised learning, unsupervised learning, and semi supervised learning. Training of the neural network is intended to minimize an output error. Training of the neural network is a process of repeatedly inputting training data into the neural network, calculating an error between an output of the neural network and a target for the training data, and updating a weight of each node of the neural network by backpropagating the error of the neural network from an output layer to an input layer of the neural network in a backward pass in order to reduce the error. In the case of supervised learning, training data in which a correct answer is labeled for each piece of training data (i.e., labeled training data) is used, and in the case of unsupervised learning, each piece of training data may not be labeled with the correct answer. That is, for example, in the case of supervised learning on data classification, the training data may be data in which each piece of training data is labeled with a category. Labeled training data is input to the neural network, and an output (category) of the neural network is compared with a label of the training data, thereby allowing the error to be calculated. As another example, in the case of unsupervised learning about data classification, an error may be calculated by comparing the training data, which is an input, with an output of the neural network. The calculated error is back-propagated in the backward direction (i.e., the direction from an output layer to an input layer) in the neural network, and a connection weight of each node in each layer of the neural network may be updated according to the back-propagation. An amount of change in the connection weight of each updated node may be determined depending on a learning rate. Computation on input data and backpropagation of errors in the neural network may constitute a training cycle (epoch). The learning rate may be applied differently depending on the number of repetitions of the training cycle of the neural network. For example, in the early stages of training of the neural network, a high learning rate may be used to increase efficiency by allowing the neural network to quickly achieve a certain level of performance, and in the later stages of the training, a low learning rate may be used to increase accuracy.

In the training of the neural network, training data may generally be a subset of real data (i.e., data intended to be processed using a trained neural network), and accordingly, there may be a training cycle in which errors for training data decrease but errors for real data increase. Overfitting is a phenomenon in which errors in real data increase due to excessive learning of a machine learning model on training data. For example, a phenomenon in which a neural network that has learned about cats by showing it orange cats fails to recognize cats other than orange cats as cats may be a type of overfitting. Overfitting can cause errors in machine learning algorithms to increase. To prevent such overfitting, various optimization methods may be used. To prevent overfitting, methods such as increasing the training data, regularization, and dropout of omitting some nodes of the network during the training process may be applied.

The operations of the methods or algorithms described in connection with the embodiment of the present invention may be implemented directly in hardware, implemented as a software module executed by hardware, or a combination thereof. The software module may reside in a RAM, a ROM, an EPROM, an EEPROM, a flash memory, a hard disk, a removable disk, a CD-ROM, or any other form of computer-readable recording medium well known in the art to which the present invention pertains.

The components of the present invention may be implemented as a program (or application) and stored in a medium to be executed by being combined with a computer which is hardware. Components of the present invention may be implemented as software programming or software elements. Similarly, the embodiments may be implemented in programming or scripting languages such as C, C++, Java, assembler, etc., including various algorithms implemented as combinations of data structures, processes, routines or other programming constructs. Functional aspects may be implemented as algorithms running on one or more processors.

Those skilled in the art will understand that various exemplary logical blocks, configurations, modules, circuits, means, logics, and algorithm steps described in connection with the embodiments disclosed herein may be implemented in electronic hardware, various forms of program or design code (referred to herein as “software” for convenience), or a combination of both. To clearly illustrate this interchangeability of hardware and software, various exemplary components, blocks, configurations, means, logics, modules, circuits, and steps have been described above generally in connection with their functionality. Whether this functionality is implemented as hardware or software depends on the design constraints imposed on the specific application and the overall system. Those skilled in the art may implement the functionality described in a variety of ways for each specific application, but such implementation decisions should not be construed as departing from the scope of the present invention.

The various embodiments presented herein may be implemented as a method, device, or article of manufacture using standard programming and/or engineering techniques. The term “article of manufacture” includes a computer program, carrier, or media accessible by any computer-readable device. For example, the computer-readable media include, but are not limited to, magnetic storage devices (e.g., hard disks, floppy disks, magnetic strips, etc.), optical discs (e.g., CDs, DVDs, etc.), smart cards, and flash memory devices (e.g., EEPROMs, cards, sticks, key drives, etc.). In addition, various storage media presented herein include one or more devices and/or other machine-readable media for storing information. The term “machine-readable media” includes, but is not limited to, wireless channels and various other media capable of storing, retaining, and/or transmitting instruction(s) and/or data.

It is to be understood that a specific order or hierarchy of steps in the processes presented is an example of illustrative approaches. It is to be understood that the specific order or hierarchy of steps in the processes may be rearranged within the scope of the present invention, based on design priorities. The appended method claims present elements of various steps in a sample order, but are not meant to be limited to the specific order or hierarchy presented.

According to the present invention, it is possible to provide a consistent and reliable anomaly detection method for welding data by analyzing data by taking into account a relationship between sensors.

The effects of the present invention are not limited to the effects mentioned above, and other effects that are not mentioned can be clearly understood by those skilled in the art from the description below.

Although embodiments of the present invention have been described above with reference to the accompanying drawings, a person skilled in the art to which the present invention pertains will understand that the present invention may be implemented in other specific forms without changing its technical idea or essential features. Therefore, the embodiments described above should be understood in all respects as illustrative and not restrictive.

What is claimed is:

1. A method for anomaly detection based on ultrasonic welding data, which is performed by a computing device including at least one processor, the method comprising:
acquiring ultrasonic welding data;
generating relational data based on a correlation between data items included in the ultrasonic welding data;
generating input data based on the ultrasonic welding data and the relational data; and
processing the input data as an input of a graph neural network (GNN) model to calculate an outlier score and detecting an anomaly in ultrasonic welding equipment based on the calculated outlier score,
wherein the GNN model includes:
an embedding model that captures a unique embedding vector corresponding to each piece of data included in the input data; and
an attention module that calculates an attention weight based on the embedding vector corresponding to each piece of data and predicts a next value of a graph based on the calculated attention weight.

2. The method of claim 1, wherein the ultrasonic welding data includes:
first sensor data obtained by measuring energy applied to a welding material;
second sensor data obtained by measuring a force applied to the welding material by a horn provided in the ultrasonic welding equipment;
third sensor data obtained by measuring an ultrasonic operating frequency in the horn;
fourth sensor data obtained by measuring an ultrasonic amplitude in the horn;
fifth sensor data obtained by measuring a distance the horn has moved from an ultrasonic trigger point; and
sixth sensor data obtained by measuring vibration acceleration at an anvil or the horn provided in the ultrasonic welding equipment.

3. The method of claim 2, further comprising generating envelope data based on the sixth sensor data included in the ultrasonic welding data when the ultrasonic welding data is acquired.

4. The method of claim 3, wherein the generating of the relational data based on the correlation between the data items included in the ultrasonic welding data includes:
generating at least one relational graph based on the first sensor data, the second sensor data, the third sensor data, the fourth sensor data, the fifth sensor data, the sixth sensor data, and the envelope data; and
generating relational data corresponding to the at least one relational graph.

5. The method of claim 1, further comprising separating the ultrasonic welding data into preset stages when the ultrasonic welding data is acquired.

6. The method of claim 5, wherein the generating of the relational data based on the correlation between the data items included in the ultrasonic welding data includes:
generating a relational graph between data for each of a plurality of sensors included in the ultrasonic welding data for each stage; and
generating relational data corresponding to the relational graph, and
the input data is classified for each stage.

7. The method of claim 1, further comprising:
acquiring past ultrasonic welding data;
selecting normal assumption data from the past ultrasonic welding data;
separating the normal assumption data into preset stages when the normal assumption data is selected;
generating a relational graph between data for each of a plurality of sensors included in the normal assumption data for each stage, and generating relational data for training corresponding to the relational graph; and
training the GNN model based on the past ultrasonic welding data and the relational data for training,
wherein the selecting of the normal assumption data among the ultrasonic welding data includes:
extracting reference data for each of the plurality of sensors from which the past ultrasonic welding data was collected;
calculating a similarity value between the data for each of the plurality of sensors included in the past ultrasonic welding data and the reference data for each of the plurality of sensors; and
selecting specific welding data whose similarity value is greater than or equal to a preset value as the normal assumption data.

8. The method of claim 1, wherein the GNN model is a neural network model that has learned a graph of relationships between data using graph deviation and configured to:
output predicted data through correlation analysis between data included in the input data; and
calculate the outlier score through a comparison between the actually acquired ultrasonic welding data and the predicted data.

9. An apparatus comprising:
a memory that stores one or more instructions; and
a processor that executes the one or more instructions stored in the memory,
wherein the processor performs the method of claim 1 by executing the one or more instructions.

10. A computer program that is stored in a computer-readable recording medium and, when executed by being combined with a computer which is hardware, causes the method of claim 1 to be performed.
